(19) United States
(12) Patent Application Publication
(10) Pub. No.: US 2015/0035251 A1
(43) Pub. Date: Feb. 5, 2015

(54) Anti-fall Device for Two Wheeled Vehicle

(71) Applicants: Yves Potin, Clermont-Ferrand Cedex 9 (FR); Eric Durand, Clermont-Ferrand Cedex 9 (FR); Daniel Beaulaton, Clermont-Ferrand Cedex 9 (FR)

(72) Inventors: Yves Potin, Clermont-Ferrand Cedex 9 (FR); Eric Durand, Clermont-Ferrand Cedex 9 (FR); Daniel Beaulaton, Clermont-Ferrand Cedex 9 (FR)

(21) Appl. No.: 13/879,577

(22) PCT Filed: Oct. 10, 2011
(86) PCT No.: PCT/EP2011/067615

§ 371 Date: May 30, 2013

(30) Foreign Application Priority Data
Oct. 15, 2010 (FR) 1058425

(51) Int. Cl. B62H 1/12; G01M 17/007

(52) U.S. Cl. CPC B62H 1/12; G01M 17/007
USPC 280/293

(57) ABSTRACT

An anti-fall device for a two-wheeled vehicle intended to prevent the vehicle and the rider thereof from falling when the camber angle reaches the limiting angle corresponding to the limit of grip of the tires, for a given circular trajectory and a given coefficient of grip, while enabling this limiting angle to be measured.

The invention relates to an anti-fall device for a two-wheeled vehicle.

Although not limited to this application, the invention shall be specifically described in relation to an anti-fall device for a two-wheeled vehicle such as a bicycle.

Developing and finalizing a tire, in particular for a two-wheeled vehicle, requires tests to be performed on the vehicle. The tests performed include tire grip tests, in particular on wet ground, and these tests are extremely important for determining the safety performance of the tire. A commonly used grip test is a transverse grip test of a two-wheeled vehicle moving around a circular trajectory at a given speed, on wet ground. This test simulates the behaviour of a tire when the vehicle is negotiating a bend and, in particular, the transverse gripping capacity thereof, i.e. the grip in a direction perpendicular to the trajectory of the vehicle. Document WO2009147235 describes a method for estimating the transverse grip of a pair of tires by comparative analysis.

It is known that a vehicle of mass M, the centre of gravity of which is moving around a circular trajectory of radius R, at a speed V, is subjected to a centrifugal force F=M*V²/R, which tends to push the vehicle off the trajectory thereof. For the vehicle to remain on the trajectory thereof, the interface between the tires and the ground needs to generate a centripetal force balancing the centrifugal force. This centripetal force is generated by the grip of the tires with the ground, which then develops a transverse friction force F_{Y} applied to the tire. The transverse friction force F_{Y}, which is the result of the friction forces applied to the two tires of the two-wheeled vehicle, depends on the vertical load F_{Z} applied by the vehicle to the ground, the ground condition and the tire material in contact with the ground. Therefore, f is defined as f=F_{Y}/F_{Z}. To enable the vehicle to follow the desired trajectory at the desired speed, f must not exceed the coefficient of grip available at the tire/ground interface, also known as the coefficient of friction.

It is also known that a two-wheeled vehicle, the centre of gravity of which is moving around a circular trajectory of radius R, at a given speed V, forms an angle C with the vertical plane tangential to the trajectory, oriented towards the inside of the trajectory, known as the camber angle. More specifically, the camber angle is the angle formed by the midplane of the vehicle, i.e. the plane of symmetry of the structure of the vehicle containing the centre of gravity of the vehicle, with the vertical plane tangential to the trajectory. The tangent of the camber angle C is proportional to the centrifugal force, i.e. to the result of the gripping forces on the tires F_{Y}, and satisfies the equation tan(C)=V²/R·g, where g is gravitational acceleration. Thus, for a given circular trajectory of radius R and a given coefficient of grip, when the speed V increases, the camber angle C increases up to a limiting angle, which corresponds to the limit of grip, beyond which the tires slide on the ground, causing the vehicle and the rider thereof to fall.

The limiting angle for a given circular trajectory and a given coefficient of grip is difficult to determine with a conventional two-wheeled vehicle, because it is difficult for the rider to hold this limiting angle, long enough for it to be measured, without falling.

The inventors intend to prevent the two-wheeled vehicle and the rider thereof from falling when the camber angle reaches the limiting angle corresponding to the limit of grip of the tires, for a given circular trajectory and a given coefficient of grip, while enabling this limiting angle to be measured.

This objective is achieved, according to the invention, by an anti-fall device for a two-wheeled vehicle fitted with tires, the centre of gravity G of the vehicle moving around a circular trajectory of centre O and radius R at a speed V, the midplane of the vehicle, containing the centre of gravity G, forming a camber angle with the vertical plane tangential to the trajectory, the camber angle increasing with the speed V and being variable between a zero angle and a limiting angle beyond which the transverse grip of the tires is lost, causing the vehicle to fall,

the anti-fall device being attached laterally to the inside of the vehicle in relation to the trajectory, limiting the camber angle, when the speed V increases, to a maximum angle strictly greater than the limiting angle,
the anti-fall device including a safety wheel, the midplane of which intersects the midplane of the vehicle along a straight line located above the ground and forming an angle that differs from the maximum angle by up to 5°, means for adjusting the maximum angle and linking means between the safety wheel and the vehicle.

The following definitions shall apply in this document:

longitudinal direction: the direction tangential to the trajectory at a point of the trajectory,

transverse direction: the direction perpendicular to the trajectory at a point of the trajectory,

vertical direction: direction perpendicular to the plane defined by the longitudinal and transverse directions,

vertical plane tangential to the trajectory: plane defined by the longitudinal and vertical directions,

horizontal plane: plane defined by the longitudinal and transverse directions.

The anti-fall device according to the invention makes it possible to achieve the limiting angle, beyond which there is a loss of tire grip, without falling. As long as the camber angle of the vehicle is less than the limiting angle, the moving tires grip the ground and the vehicle moves along the trajectory thereof. When the limiting angle is reached, the tires begin to slide and the camber angle increases very quickly. The camber angle is then locked, by the anti-fall device, at a maximum angle greater than the limiting angle, which both prevents the vehicle and the rider thereof from falling and enables the vehicle to continue moving along the trajectory thereof.

The principle of a maximum camber angle strictly greater than the grip-limit angle makes it possible to measure this limiting angle during a test, because this limiting angle falls within the range of permitted camber angles. This principle of locking the camber angle after grip is lost is not suitable for a conventional safety device, in which the camber angle is intended to be locked before the grip limit is reached.

In practice, the maximum camber angle of the anti-fall device is initially set to a predetermined value, which permits a maximum given speed, as a function of the radius of the trajectory and of the coefficient of grip of the ground. If the tires lose grip at a speed lower than this maximum authorized speed, i.e. at a limiting angle less than the predetermined maximum angle, the limiting angle and the corresponding limiting speed may be determined with this maximum angle setting. On the other hand, if grip is not lost at a speed less than the maximum authorized speed, i.e. at a limiting angle less than the predetermined maximum angle, the maximum angle needs to be set to a higher value.

The anti-fall device is attached laterally to the inside of the vehicle in relation to the trajectory, i.e. on the side towards which the vehicle is inclined. Lateral attachment means that the anti-fall device is substantially positioned on the axis of the centre of gravity of the vehicle, i.e. neither level with the rear wheel nor level with the front wheel, but between the two wheels.

The anti-fall device includes a safety wheel, the midplane of which intersects the midplane of the vehicle along a straight line located above the ground forming an angle that differs from the maximum angle by up to 5°, means for adjusting the maximum angle and linking means between the safety wheel and the vehicle.

The safety wheel is a simple, effective and cheap means of performing the anti-fall function. As an auxiliary wheel, the safety wheel has the advantage of enabling the vehicle to continue moving on three wheels, having tipped towards the inside of the trajectory, following the loss of tire grip. The fact that the safety wheel has a midplane that intersects the midplane of the vehicle along a straight line located above the ground forming an angle that differs from the maximum angle by up to 5° means that the safety wheel comes into contact with the ground in a substantially vertical direction. Substantially vertical direction means an incline of the midplane of the safety wheel of less than ±5° from the vertical. A near-vertical contact of the safety wheel with the ground, i.e. with a near-zero camber angle of the safety wheel, does not generate any transverse force liable to disturb the trajectory of the vehicle and enables the vehicle to continue the trajectory thereof without risk of falling.

Means for adjusting the maximum angle make it possible to scan through the range of maximum angles required to determine the limiting angles and the limiting speeds in terms of grip on different types of dry or wet road surfaces.

Linking means between the safety wheel and the vehicle make it possible to rigidly connect the safety wheel to the vehicle, usually, but not always, detachably. The linking means also have a structural interface with the maximum-angle adjustment means.

Advantageously, the maximum angle is at least 10° and at most 60°, and preferably at least 20° and at most 45°.

An adjustment range of the maximum angle between 10° and 60° makes it possible to determine the limiting angle and the corresponding limiting speed, for different types of dry or wet road surfaces of different granulometries for a wide range of ground grip-coefficient values. Conventionally, tires are tested on asphalt or bituminous road surfaces with relatively high coefficients of grip, for example around 1.0, and polished-concrete road surfaces with relatively low coefficients of grip, around 0.1 to 0.2. A preferential maximum-angle adjustment range of between 20° and 45° makes it possible to test the transverse grip of the tires on the most common road surfaces, for speeds of between 0 and 40 km/h characteristic of a two-wheeled vehicle such as a bicycle.

It is also advantageous that the centre of the safety wheel of an anti-fall device be positioned at a distance from the midplane of the vehicle such that the centre of the safety wheel describes a circular trajectory, the centre of which is coaxial to the centre of the circular trajectory of the centre of gravity of the vehicle, and the radius of which is not greater than the radius of the circular trajectory of the centre of gravity of the vehicle.

Such a positioning of the centre of the wheel in relation to the midplane of the vehicle, in a transverse direction, ensures that the projection of the centre of gravity of the vehicle is positioned between the ground line of the midplane of the vehicle, passing substantially through the ground contact points of the front and rear tires of the vehicle, and the ground contact point of the safety wheel, which prevents the vehicle-rider ensemble from tipping, by rotation about the longitudinal direction, and therefore falling.

A safety wheel advantageously has an external diameter at least equal to half the external diameter of the tires fitted to the two-wheeled vehicle. This feature makes it possible to limit the distance between the centre of the safety wheel and the midplane of the vehicle, and therefore to reduce the transverse footprint of the anti-fall device and to improve the handling capability of the vehicle fitted with such an anti-fall device.

It is also advantageous that the centre of the safety wheel of an anti-fall device be positioned substantially in the vertical plane passing through the centre of gravity of the vehicle and perpendicular to the midplane of the vehicle.

Centre of gravity of the vehicle means the centre of gravity of the vehicle, with the rider thereof, when the vehicle is fitted with the anti-fall device. Positioning the centre of the wheel in a vertical plane passing through the centre of gravity of the vehicle and perpendicular to the midplane of the vehicle makes it possible to maintain the distribution of the vertical load of the vehicle-rider ensemble between the front wheel and the rear wheel. Typically, 30% of the vertical load is applied to the front wheel and 70% of the vertical load is applied to the rear wheel. Maintaining the load distribution in this way prevents the circular trajectory of the vehicle from being disturbed by yawing, i.e. rotation about a vertical axis passing through the centre of gravity of the vehicle when the safety wheel comes into contact with the ground. It is not essential to position the centre of the wheel exactly in the vertical plane defined above, which is in any case difficult to achieve in practice on account of the variability of the position of the centre of gravity of the rider. A position substantially in said vertical plane, i.e. in the vicinity thereof, is acceptable.

The straight line that is the intersection between the substantially horizontal ground and the midplane of the safety wheel in contact with the ground forms a constant angle of opening of between 0° and 5° with the straight line that is the intersection between the midplane of the vehicle and the substantially horizontal ground.

The angle of opening means the angle between the two straight lines that diverge in the direction of movement. The angle of opening enables the vehicle to remain on the circular trajectory thereof after the safety wheel has come into contact with the ground. As the circular trajectory of the vehicle is maintained after the safety wheel has come into contact with the ground, the rider need not make any correction of the trajectory by moving the handlebars of the vehicle, which could destabilize the vehicle and cause a fall. The constant angle of opening is selected as a function of the radius of the circular trajectory, increasing as this radius decreases. For the limiting case of an infinite radius, corresponding to a straight-line trajectory, the angle of opening is zero.

The means for adjusting the maximum camber angle can be designed to offer a discrete number of maximum-angle values within the range [10°, 60°]. In other words, not all of the angular values between 10° and 60° can be obtained using the adjustment means, only a finite number thereof. For example, the adjustment means may enable the maximum angle to be adjusted in 2.5° increments.

A variant of the adjustment means advantageously enables any maximum-angle value in the range [10°, 60°] to be obtained, enabling a more precise adjustment of the anti-fall device.

The adjustment means are advantageously positioned between the safety wheel and the linking means, and are also advantageously attached detachably to the safety wheel and to the linking means. This positioning of the adjustment means has the advantage of being simple, because it enables adjustment to the interface with the safety wheel, for example by adjusting the position of the centre of the wheel in relation to the linking means. Furthermore, it facilitates the detachability of the adjustment means: the wheel is simply removed to access the adjustment means. The adjustment means may be positioned between the linking means and the vehicle, but this a priori makes access to the adjustment means more difficult.

An advantageous variant is having adjustment means adjustable in a fixed direction, in order to obtain a given maximum angle within the range [10°, 60°]. Unidirectional adjustment has the advantage of being simple.

By way of example, adjusting means adjustable in a fixed direction include a stop of triangular section, one face of which is attached to the linking means and another face of which is attached to the safety wheel. The movement of the attachment to the safety wheel, along the relevant face of the triangle, makes it easy to scan through several maximum-angle values, the attachment to the linking means remaining in place.

The linking means advantageously include an non-deformable tubular structure. Tubular structure means, for example, an assembly of tubes arranged in twos to form a mesh, such as a three-tube tetrahedral structure. Non-deformable structure means a structure susceptible to very limited deformation under the stresses applied on account of the rigidity thereof. It is known that a tubular structure provides the rigidity required to be considered non-deformable, while guaranteeing a relatively low structural mass.

A preferred tubular structure variant is an non-deformable metal tubular structure, preferably made of aluminium. Indeed, aluminium has the advantage of being a material that is easy to use, lightweight and cheap. A tubular structure made of carbon could also be used on account of the lightness and rigidity thereof, although it is less cheap than an aluminium structure.

Linking means in the form of a tubular structure also have the advantage of being configurable to satisfy ergonomic and safety requirements.

With regard to ergonomics, the tubular structure can be arranged to enable the rider's leg to pass between the vehicle and the safety wheel and, where applicable, to enable the rider's foot to be stopped, for example by attaching a footrest to the tubular structure.

With regard to safety, the tubular structure can be arranged to protect the rider's foot and ankle on the side of the anti-fall device. Indeed, when the tires lose grip and the vehicle tips to the maximum angle, the rider will instinctively place his foot on the ground on the side of the anti-fall device, hence the need to install protection means, such as for example a net attached to the tubular structure enabling the rider's foot to be held when the vehicle tips, thereby preventing the rider's foot from being caught between the ground and the linking means.

The invention also relates to a two-wheeled vehicle fitted with an anti-fall device as described above, and in particular a test bicycle.

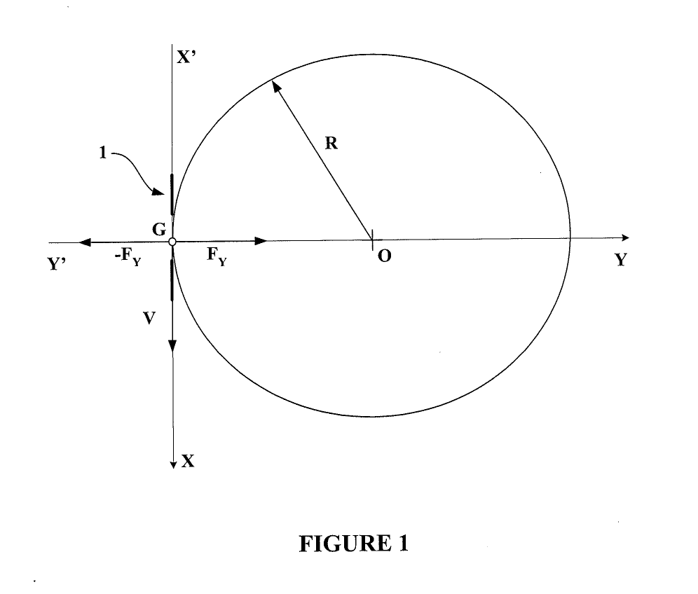

The features and other advantages of the invention can be better understood using FIGS. 1 to 3B attached.

FIGS. 1 to 3B are not shown to scale.

FIG. 1 shows a top view of a two-wheeled vehicle 1 with centre of gravity G, moving around a circular trajectory of centre O and radius R at a speed V tangential to the trajectory. An orthonormal frame with longitudinal axis XX′, transverse axis YY′ and vertical axis ZZ′ (not shown as it is perpendicular to the plane XY) is defined on G. The two-wheeled vehicle of mass M, M being the mass of the vehicle-rider ensemble, is subject to the centrifugal force −F_{Y}=M*V²/R applied to the centre of gravity G of the vehicle-rider ensemble and balanced by the centripetal force F_{Y}. The vehicle-rider ensemble is also subject to the vertical load F_{Z}=Mg, where g is gravitational acceleration, not shown as it is perpendicular to the plane XY.

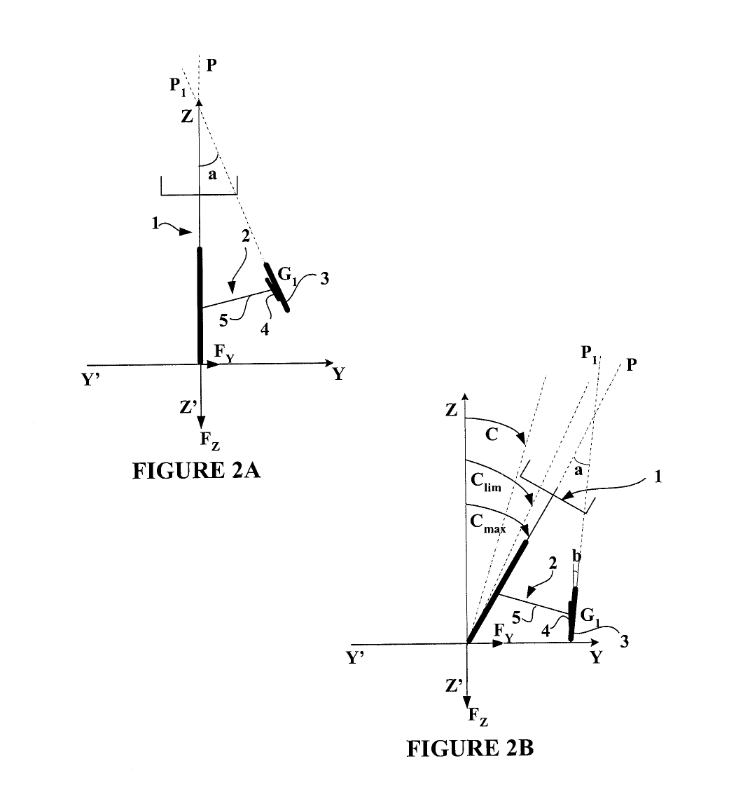

FIG. 2A shows a two-wheeled vehicle 1 fitted with an anti-fall device 2, the midplane of the vehicle P being tangential to the trajectory, i.e. in the plane XZ. The anti-fall device 2 includes a safety wheel 3 of centre G₁, the midplane P₁ of which intersects the midplane P of the vehicle 1 along a straight line located above the ground forming an angle that differs from the maximum angle Cₘₐₓ by up to 5°, means 4 for adjusting the maximum angle Cₘₐₓ and linking means 5 between the safety wheel 3 and the vehicle 1. The transverse friction force F_{Y}, resulting from the friction forces on each of the tires, and the vertical load F_{Z} caused by the mass of the vehicle, fitted with the anti-fall device, and the rider, said load exerted on the ground, are shown at the interface of the vehicle with the ground.

FIG. 2B shows a two-wheeled vehicle 1 fitted with an anti-fall device 2, after the grip limit has been reached. Once the ratio f=F_{Y}/F_{Z} has reached the coefficient of grip available at the tire/ground interface for the limiting angle Cₗᵢₘ, the camber angle C continues to increase, on account of the sliding of the tires on the ground, up to the maximum angle Cₘₐₓ, to which the anti-fall device is set to stop the incline of the vehicle and to prevent it falling. In this arrangement, the vehicle continues to move on three wheels: the two wheels of the vehicle and the safety wheel 3. The midplane P₁ of the safety wheel 3 of the anti-fall device 2 forms an angle a with the midplane P of the vehicle 1 and, when the safety wheel 3 comes into contact with the ground, it forms an angle b of less than 5° with the vertical direction ZZ′, i.e. the safety wheel 3 is positioned substantially vertically in relation to the ground. The anti-fall device 2 also includes means 4 for adjusting the maximum angle Cₘₐₓ and linking means 5 between the safety wheel 3 and the vehicle 1.

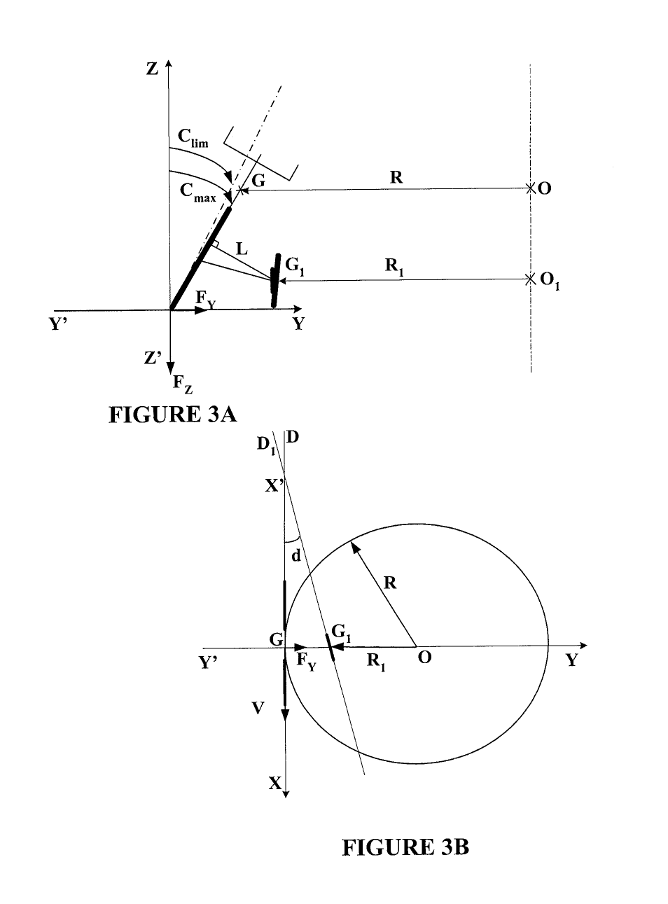

FIG. 3A shows the two-wheeled vehicle 1 inclined at a camber angle equal to the maximum angle Cₘₐₓ, and therefore moving on the two wheels of the vehicle 1 and on the safety wheel 3. The centre G₁ of the safety wheel 3 is positioned at a distance L from the midplane P of the vehicle such that the centre G₁ of the safety wheel 3 describes a circular trajectory, the centre O₁ of which is coaxial to the centre O of the circular trajectory of the centre of gravity G of the vehicle, and the radius R₁ of which is not greater than the radius R of the circular trajectory of the centre of gravity G of the vehicle 1.

FIG. 3B is a top view of the vehicle 1 inclined at a camber angle equal to the maximum angle Cₘₐₓ, and therefore moving on the two wheels of the vehicle 1 and on the safety wheel 3. This figure shows that the centre G₁ of the safety wheel is positioned substantially in the vertical plane YZ passing through the centre of gravity G of the vehicle and perpendicular to the midplane P of the vehicle. Furthermore, this figure shows the orientation of the midplane P₁ of the safety wheel 3 in relation to the midplane P of the vehicle 1 in the plane XY: the straight line D₁, being the intersection between the substantially horizontal ground and the midplane P₁ of the safety wheel 3 in contact with the ground, forms an angle of opening d of between 0° and 5° with the straight line D, being the intersection between the midplane P of the vehicle and the substantially horizontal ground, enabling the vehicle to remain on the circular trajectory thereof after the safety wheel has come into contact with the ground.

The invention is more specifically designed for a two-wheeled test vehicle, such as a bicycle, the anti-fall device of which includes:

a safety wheel of diameter substantially equal to half the external diameter of the tires tested,

means for adjusting the maximum angle in the form of a metal stop positioned between the safety wheel and the linking means, enabling the maximum angle to be adjusted between 20° and 45° at 2.5° increments,

linking means in the form of a tubular structure made of three tubes forming a tetrahedron the top of which is connected to the safety wheel and the base of which to the frame of the bicycle.

Furthermore, the arrangement of a conventional bicycle needs to be adapted to ensure compatibility of the test vehicle with the anti-fall device, as follows:

Removal of the pedal on the side of the anti-fall device to prevent contact of the pedal with the ground at high camber angles, and to enable installation of the tubular linking structure.

Locking the pedal on the side opposite the anti-fall device in horizontal position.

Building a foot rest into the tubular linking structure.

Attaching a protective net to the tubular linking structure.

Motorizing the vehicle using an electric motor built into the rear wheel and powered by a battery attached to the vehicle, to enable the bicycle to be moved without pedalling.

System for measuring the spatial position of the vehicle at all times, built into the bicycle.

Transverse grip tests were carried out using the test bicycle described above, fitted with an anti-fall device according to the invention and able to move at a maximum speed of up to approximately 40 km/h on a circular track of radius R=9 m and on different types of wet road surface. The limiting angle Cₗᵢₘ on wet bituminous ground (rough ground) was measured at approximately 40° at a speed V of 35 km/h. The limiting angle Cₗᵢₘ on wet polished concrete (smooth ground) was measured between 25 and 30° at a speed of between 23 and 30 km/h.

The invention should not be understood to be limited to the embodiments described above, but may be extended to other embodiments, such as the following non-limiting examples:

an anti-fall device including linking means other than a tubular mesh,

an anti-fall device with multidirectional adjustment means,

an anti-fall device in which the maximum locking angle Cₘₐₓ is continually adjustable during testing as a function of the grip conditions encountered,

an anti-fall device designed for a two-wheeled vehicle such as a motorcycle that can move at speeds greater than 40 km/h.

1. An anti-fall device for a two-wheeled vehicle fitted with tires, the centre of gravity of the vehicle moving around a circular trajectory of centre O and radius R at a speed V, the midplane of the vehicle, containing the centre of gravity, forming a camber angle with the vertical plane tangential to the trajectory, the camber angle increasing with the speed V of the vehicle and being variable between a zero angle and a limiting angle (Cₗᵢₘ) beyond which the transverse grip of the tires is lost, causing the vehicle to fall, the anti-fall device being attached laterally to the inside of the vehicle in relation to the trajectory, limiting the camber angle (C), when the speed V increases, to a maximum angle (Cₘₐₓ) strictly greater than the limiting angle (Cₗᵢₘ), wherein the anti-fall device includes a safety wheel of centre, the midplane of which intersects the midplane of the vehicle along a straight line located above the ground and forming an angle that differs from the maximum angle (Cₘₐₓ) by up to 5°, means for adjusting the maximum angle (Cₘₐₓ) and linking means between the safety wheel and the vehicle.

2. The anti-fall device for a two-wheeled vehicle according to claim 1, wherein the maximum angle (Cₘₐₓ) is at least 10° and at most 60°.

3. The anti-fall device for a two-wheeled vehicle according to claim 1, wherein the centre of the safety wheel is positioned at a distance from the midplane of the vehicle, such that the centre of the safety wheel describes a circular trajectory, the centre of which is coaxial to the centre of the circular trajectory of the centre of gravity of the vehicle, and the radius of which is not greater than the radius of the circular trajectory of the centre of gravity of the vehicle.

4. The anti-fall device for a two-wheeled vehicle according to claim 1, wherein the centre of the safety wheel is positioned substantially in the vertical plane passing through the centre of gravity of the vehicle and perpendicular to the midplane of the vehicle.

5. The anti-fall device for a two-wheeled vehicle according to claim 1, wherein the straight line that is the intersection between the substantially horizontal ground and the midplane of the safety wheel in contact with the ground forms an angle of opening of between 0° and 5° with the straight line that is the intersection between the midplane of the vehicle and the substantially horizontal ground.

6. The anti-fall device for a two-wheeled vehicle according to claim 1, wherein the adjustment means are configured to form a discrete number of maximum angle (Cₘₐₓ) values within the range [10°, 60°].

7. The anti-fall device for a two-wheeled vehicle according to claim 1, wherein the adjustment means are configured to form any maximum angle (Cₘₐₓ) value within the range [10°, 60°].

8. The anti-fall device for a two-wheeled vehicle according to claim 1, wherein the adjustment means are positioned between the safety wheel and the linking means.

9. The anti-fall device for a two-wheeled vehicle according to claim 1, wherein the adjustment means are attached detachably to the safety wheel and to the linking means.

10. The anti-fall device for a two-wheeled vehicle according to claim 1, wherein the adjustment means are adjustable in a fixed direction, in order to obtain a given maximum angle (γmax) within the range [10°, 60°].

11. The anti-fall device for a two-wheeled vehicle according to claim 1, wherein the linking means include a non-deformable tubular structure.

12. The anti-fall device for a two-wheeled vehicle according to claim 1, wherein the linking means include a non-deformable metal tubular structure.

13. A two-wheeled vehicle fitted with an anti-fall device according to claim 1.

14. The anti-fall device for a two-wheeled vehicle according to claim 1, wherein the maximum angle (Cₘₐₓ) is at least 20° and at most 45°.

15. The anti-fall device for a two-wheeled vehicle according to claim 12, wherein the non-deformable metal tubular structure is aluminum.
